(19) United States
(12) Patent Application Publication
(10) Pub. No.: US 2016/0232525 A1
(43) Pub. Date: Aug. 11, 2016

(54) ONLINE FORM FILL FOR TOKENIZED CREDENTIALS

(71) Applicant: MasterCard International Incorporated, Purchase, NY (US)

(72) Inventor: Axel Cateland, Scarsdale, NY (US)

(21) Appl. No.: 15/041,830

(22) Filed: Feb. 11, 2016

Related U.S. Application Data
(60) Provisional application No. 62/114,734, filed on Feb. 11, 2015.

(51) Int. Cl. G06Q 20/40; H04L 29/06

(52) U.S. Cl. CPC G06Q 20/401; H04L 63/08; G06Q 2220/00

(57) ABSTRACT

A request may be received for a transaction. In response to the request, a nonce value may be generated. A cryptographic key may be used to cryptographically process a payment token with the nonce value to produce a security code. The payment token, the nonce value and the security code may be transmitted together as payment credentials. In some cases, the nonce value may be in the format for a payment account expiration date.

### CROSS REFERENCE TO RELATED APPLICATIONS

This application claims the benefit of U.S. Provisional Patent Application No. 62/114,734 filed on Feb. 11, 2015, the contents of which are hereby incorporated by reference for all purposes.

### BACKGROUND

Payment accounts such as credit card accounts and debit card accounts are in widespread use. In one conventional manner of accessing a payment account, the account holder presents a plastic card at the point of sale in a retail store. The point of sale device reads account information from the card (e.g., via a magnetic stripe or through wireless communication with an integrated circuit in the card, or via electrical contacts on the card) and initiates a payment account transaction using the information read from the card.

Payment accounts are also widely used in e-commerce. For example, an account holder may use a personal computer or a smartphone to access a merchant's online store webpage. After selecting goods for purchase and then opting for “check out”, the account holder is prompted to enter his/her payment account information into a data entry screen downloaded to his/her computer (or smartphone). The merchant's e-commerce host computer then initiates a payment account transaction using the information that was entered by the account holder.

Given that many users of payment accounts may have more than one such account, there have been proposals for so-called digital wallets. According to one type of proposed arrangement, a wallet service provider (WSP) maintains digital wallets for a large number of users. Each user causes some or all of his/her payment accounts to be enrolled in his/her digital wallet, and the WSP stores the corresponding information in a data partition that is dedicated to the respective user and thus forms his/her digital wallet. When the user seeks to check out at the conclusion of an e-commerce shopping transaction, the user is given the option to access his/her wallet at the wallet service provider. Via data communication among the user's computer/smartphone, the merchant's e-commerce host computer and the WSP's computer, the user is presented with an option to select one of his/her enrolled payment accounts for use in the current e-commerce transaction. This may involve interaction between the WSP and the user via the browser on the user's device, and may include the user selecting the desired payment account from his/her digital wallet. An outcome of this interaction may be that the user's payment credentials are received by the browser from the WSP and are automatically input by the user's browser into a payment information form downloaded to the user's device by the e-commerce site as part of the checkout process.

The present inventor has recognized opportunities to enhance the security of payment transactions while facilitating automatic fill-in of payment information forms for e-commerce checkout operations.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a payment system provided in accordance with aspects of the present disclosure.

FIG. 2 is a block diagram that illustrates a computer system that may be provided as part of the system of FIG. 1 and in accordance with aspects of the present disclosure.

FIG. 3 is a block diagram that illustrates another computer system that may be provided as part of the system of FIG. 1 and in accordance with aspects of the present disclosure.

FIG. 4 is a flow chart that illustrates a process that may be performed in the system of FIG. 1 in accordance with aspects of the present disclosure.

### DETAILED DESCRIPTION

In general, and for the purpose of introducing concepts of embodiments of the present disclosure, a WSP may store a user's payment credentials in tokenized form. To facilitate security for payment credential fill-in, the WSP may use a cryptographic key to cryptographically generate a security code based on the user's payment token and a nonce value generated randomly or quasi randomly by the WSP. In some embodiments, the nonce value may be in the format usually required for an account expiration date. The WSP may pass the payment token, the nonce value and the security code to the user's browser for automatic fill-in of the payment information for an e-commerce checkout operation. The nonce value may be passed to the merchant in the expiration date data field. After the merchant submits a transaction authorization request using the filled-in information, a downstream payment service provider may verify the security code using the same cryptographic key that was employed by the WSP. This may have the effect of demonstrating that the WSP was in fact the source of the payment credentials and/or that the user satisfied a user authentication process conducted by the WSP. As a result, a higher degree of confidence may be ascribed to the legitimacy of the payment transaction.

As used in this disclosure and the appended claims, the term “payment token” shall have the same meaning attributed to it in connection with the tokenization standard published by MasterCard International Incorporated, Visa and American Express in November, 2013. (As is familiar to those who are skilled in the art, the tokenization standard referred to in the prior sentence was entitled “Payment Token Interoperability Standard.”) To briefly summarize the meaning of the term, a payment token may be a value or number that takes the place of a primary account number (PAN) during a portion of a payment transaction process. One example of a payment token may be a so-called DPAN (device PAN), which may be stored in payment devices in lieu of a PAN. It is also to be noted that the term DPAN may be applied to payment tokens that are not stored in payment devices.

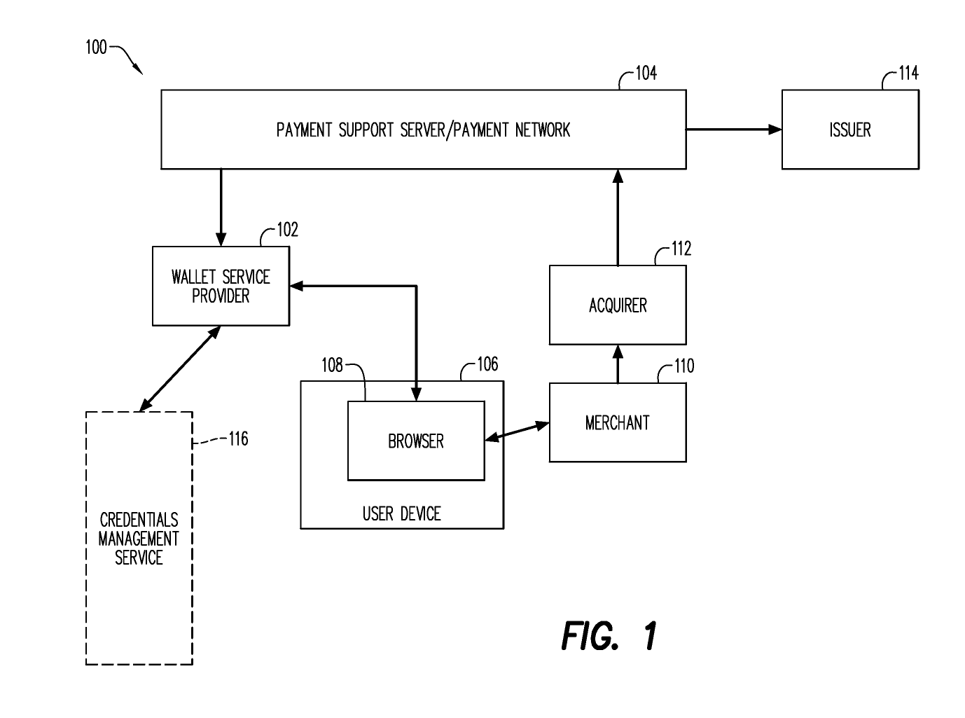

FIG. 1 is a block diagram that illustrates a payment system 100 provided in accordance with aspects of the present disclosure.

Each block shown in FIG. 1 may be taken to represent a party that participates in or facilitates a payment transaction and/or one or more computing devices operated by such party.

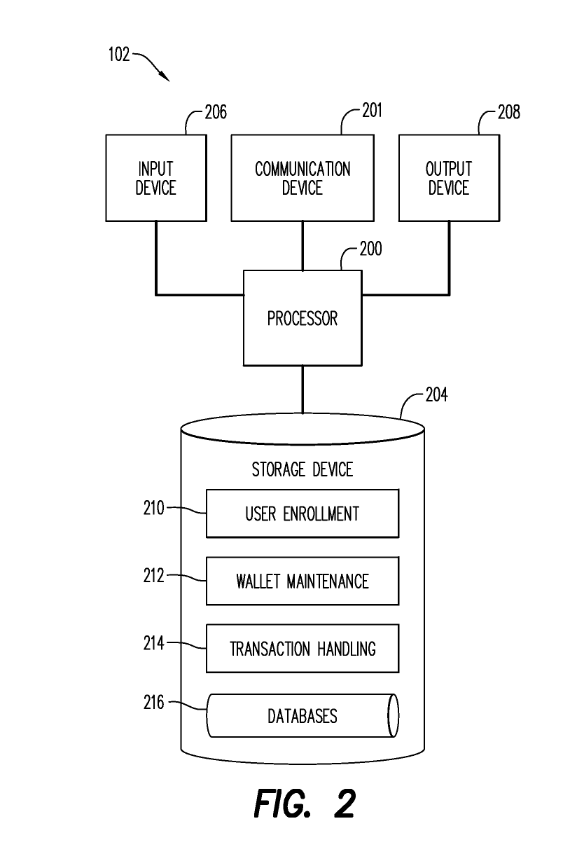

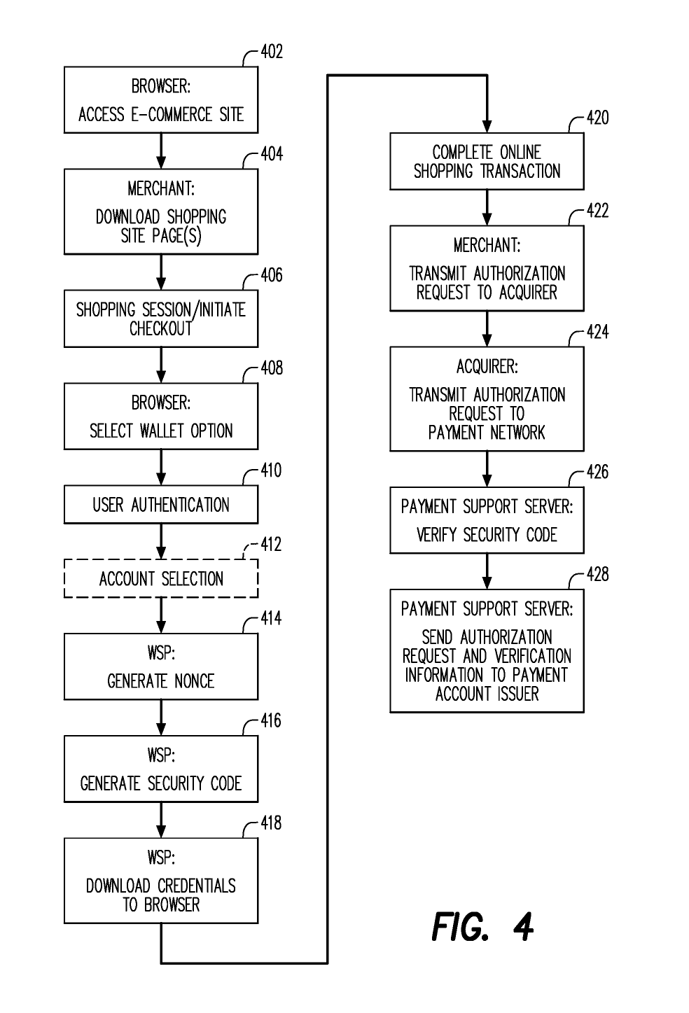

Block 102 in FIG. 1 represents a wallet service provider (WSP) computer. The WSP computer 102 may provide enhanced transaction security services in accordance with aspects of the present disclosure. Features of the WSP computer 102 and/or functions performed by the WSP computer 102 will be described below in connection with FIGS. 2 and 4.

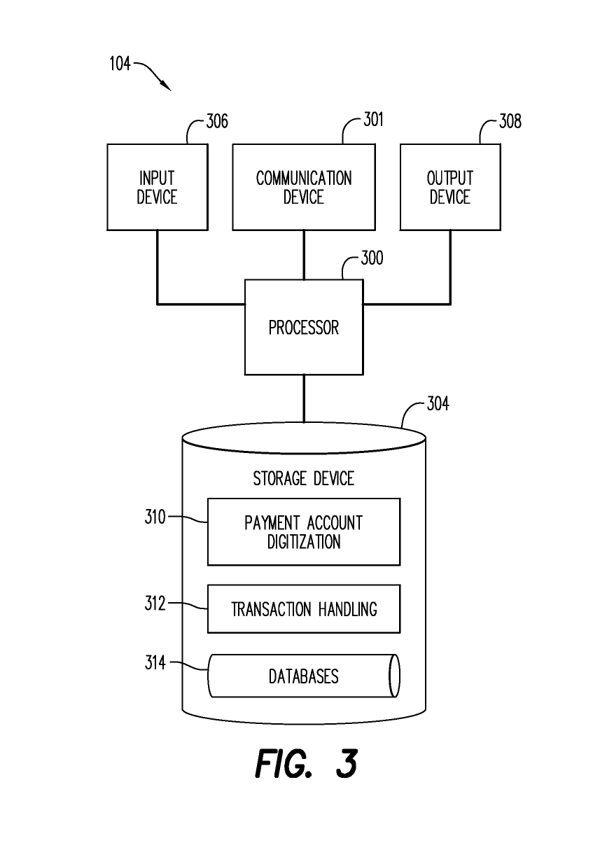

Block 104 in FIG. 1 represents a payment network as well as one or more payment support services computers operated in association with the payment network. These facilities may in some cases below be referred to either as “payment support services computer 104” and/or “payment network 104”, since all of these facilities may, in some embodiments, be constituted by a single computer or a group of cooperating computer systems. Features of the payment support services computer 104 and/or functions performed by the payment support services computer 104 will be described below in connection with FIGS. 3 and 4. One function worth noting at this point is that the payment support services computer 104 may be a source of payment credential data for the WSP computer 102 in connection with subscribers to the WSP and related to one or more of their payment accounts. Thus the payment support services computer 104 may facilitate so-called digitization of users' payment accounts into user account partitions maintained by the WSP computer 102.

The payment support services computer 104 may also function as a “token requestor” as described in the above-mentioned tokenization standard. In some embodiments, the payment support services computer 104 may supply the WSP computer 102 with payment tokens that represent users' accounts, and may also supply to the WSP computer 102 one or more cryptographic keys to be employed as described below. In other embodiments, the WSP may act as the token requestor.

It should also be understood that, in many of its functions, the payment network 104 may duplicate or closely resemble the functionality of existing payment networks. One well known example of a payment network is referred to as the “Banknet” system, and is operated by MasterCard International Incorporated, which is the assignee hereof.

Block 106 in FIG. 1 represents a user device by which the user may access and interact with an e-commerce website. As will be appreciated from earlier discussion, the user device 106 may be, for example, a personal computer or a smartphone that runs a mobile browser. In other possible embodiments, the user device 106 may be a tablet computer, a laptop computer, a game console or a smartwatch. One software feature of the user device 106 may be a browser program 108. The browser program 108 may handle internet-based interactions between the user device 106 and other devices. For present purposes, such other devices may include the WSP computer 102 and a merchant 110 that operates an e-commerce website.

The hardware and software features of a typical user device 106 are familiar to those who are skilled in the art, and need not be described or illustrated in detail. It is sufficient to note that the user device 106 most likely includes a processor (not separately shown) of some type, programmed and controlled by software instructions stored in one or more memory devices (not separately shown), which are also part of the user device 106.

A computer 112 operated by an acquirer (acquiring financial institution) is also shown as part of the system 100 in FIG. 1. The acquirer computer 112 may operate in a conventional manner to receive an authorization request for a payment account transaction from the merchant 110. The acquirer computer 112 may route the authorization request via the payment network 104 to a server computer 114 operated by the issuer of a payment account that the user has elected to employ for the payment account transaction. As will be seen from subsequent discussion, a verification/security function may also be carried out by the payment support services computer 104 in association with the routing performed by the payment network 104. The authorization response generated by the issuer computer 114 may be routed back to the merchant 110 via the payment network 104 and the acquirer computer 112.

The issuer computer 114 may be operated by or on behalf of a financial institution (“FI”) that issues payment accounts to individual users. For example, the issuer computer 114 may perform such functions as (a) receiving and responding to requests for authorization of payment account transactions to be charged to payment accounts issued by the FI; and (b) tracking and storing transactions and maintaining account records.

Block 116, shown in phantom, represents a computer operated by a credential management service (CMS). In some embodiments, the CMS computer 116 may, as discussed below, cooperate with the WSP computer 102 in facilitating payment account transactions.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their computer systems. The system 100 may also include a very large number of payment account holders/users, who may use their payment accounts for online shopping transactions. Of course, in many cases the payment accounts may also be represented by payment cards that the user may employ for in-store transactions at point of sale terminals (not shown). In accordance with aspects of the concept of tokenization, the payment card used to access a particular payment account may, in some cases, store and/or display a payment token that differs from the payment token stored by the WSP computer 102 for the same user and same payment account.

FIG. 2 is a block diagram that illustrates an example embodiment of the WSP computer 102 as shown in FIG. 1 and provided in accordance with aspects of the present disclosure.

Referring now to FIG. 2, the WSP computer 102 may be conventional in its hardware aspects but may be controlled by software to cause it to function as described herein. For example, the WSP computer 102 may be constituted by conventional server computer hardware.

The WSP computer 102 may include a computer processor 200 operatively coupled to a communication device 201, a storage device 204, an input device 206 and an output device 208. In some embodiments, the WSP computer 102 may also include an HSM (Hardware Security Module; not shown) to aid in assuring security of data stored in the WSP computer 102.

The computer processor 200 may be constituted by one or more conventional processors. Processor 200 operates to execute processor-executable steps, contained in program instructions described below, so as to control the WSP computer 102 to provide desired functionality.

Communication device 201 may be used to facilitate communication with, for example, other devices (such as the payment support services computer 104, and the user device 106). For example, the communication device 201 may include numerous communication ports and interfaces to facilitate communications over-the-air via one or more mobile communication networks (not shown) with mobile devices operated as user devices by numerous users of the payment system 100 and/or the communication device 201 may facilitate numerous calls for service via the Internet by user devices.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the WSP computer 102, executed by the processor 200 to cause the WSP computer 102 to function as described herein.

The programs may include one or more conventional operating systems (not shown) that control the processor 200 so as to manage and coordinate activities and sharing of resources in the WSP computer 102, and to serve as a host for application programs (described below) that run on the WSP computer 102.

The programs stored by the storage device 204 may include, for example, a user enrollment application program 210. The user enrollment application program 210 may control the processor 200 to enable the WSP computer 102 to handle requests from users to enroll for wallet services provided by the WSP computer 102. For example, this may include, at least in part, opening a user account on the WSP computer 102 and digitizing one or more of the user's payment accounts for inclusion in the digital wallet/user partition to be provided for the user on the WSP computer 102. In some embodiments, digitization of the user's payment accounts may, in at least some cases, be via payment tokens requested by the payment support services computer 104 and supplied by the payment support services computer 104 to the WSP computer 102. In other cases, the WSP computer 102 may serve as the token requestor and the payment support services computer 104 may serve as the token supplier/token vault.

The user's interaction with the WSP computer 102 to establish the user's digital wallet may, for example, be via access to a website hosted by the WSP computer 102.

The storage device 204 may also store a wallet maintenance application program 212 that controls the processor 200 to enable the WSP computer 102 to store and maintain the digital wallets that have been established by users in the WSP computer 102.

The storage device 204 may also store a payment transaction handling program 214, which controls the processor 200 to enable the WSP computer 102 to handle device and/or user authentication and wallet account selection for numerous transactions requested by users. Details of transaction handling by the WSP computer 102 will be described below, particularly with reference to FIG. 4A. As noted above, the transaction handling by the WSP computer 102 may, in at least some cases, include enhanced security functions, including generation of a dynamic security code (akin to a dynamic CVC) by cryptographic processing using a cryptographic key or keys supplied to the WSP computer 102 by the payment support services computer 104.

The storage device 204 may also store, and the WSP computer 102 may also execute, other programs, which are not shown. For example, such programs may include a reporting application, which may respond to requests from system administrators for reports on the activities performed by the WSP computer 102. The other programs may also include, e.g., one or more data communication programs, website hosting programs, a database management program, device drivers, etc.

The storage device 204 may also store one or more databases 216 required for operation of the WSP computer 102. Such databases may include, for example, a database (not separately indicated in FIG. 3) for storing data corresponding to digital wallets and associated digitized payment accounts maintained for users/cardholders in the WSP computer 102.

FIG. 3 is a block diagram that illustrates an example embodiment of the payment support services computer 104 as shown in FIG. 1 and provided in accordance with aspects of the present disclosure.

In some embodiments, the payment support services computer 104 may have a similar hardware architecture to that described above in connection with the WSP computer 102. For example, in some embodiments, the payment support services computer 104 may include a processor 300, a communication device 301, a storage device 304, an input device 306 and an output device 308. These components may resemble the corresponding components as described in connection with the WSP computer 102 and may interact with each other in like manner as described above with respect to the corresponding components of the WSP computer 102. Accordingly, it is not necessary to repeat the hardware description that accompanied FIG. 2. However, the functionality of the payment support services computer 104 shown in FIG. 3 may differ from that of the WSP computer 102, and consequently the software programs stored in the storage device 304 to control the processor 300 may be at least partially different from the software programs described above in connection with the WSP computer 102.

One program that may be stored in the storage device 304 of the payment support services computer 104 may be a payment account digitization program 310. The payment account digitization program 310 may, in some embodiments, control the processor 300 such that the payment support services computer 104 functions to handle requests from the WSP computer 102 and/or other wallet service providers and/or from users for digitization of payment accounts that belong to users of the WSPs in question.

In addition, the storage device 304 may store a transaction handling program 312. In some of its aspects, the transaction handling program 312 may control the processor 300 such that payment support services computer 104 (which may also be seen as embodying aspects of a payment network) performs customary routing functions for authorization requests received from acquirers and authorization responses received from issuers. Furthermore, and in accordance with aspects of the present disclosure, the payment support services computer 104 may, under control of the transaction handling program 312, perform security-related functions as described below in connection with FIG. 4.

The storage device 304 may also store one or more databases 314 required for operation of the payment support services computer 104.

FIG. 4 is a flow chart that illustrates a process that may be performed in the payment system 100 in accordance with aspects of the present disclosure.

A typical transaction may begin when the user (not shown) operates the user device 106 such that the browser program 108 accesses (block 402 in FIG. 4) an e-commerce website (not separately shown) operated by the merchant 110. As indicated by block 404, the merchant 110 may respond by downloading to the user device 106 one or more webpages that make up the e-commerce website. The user may operate the user device 106 and control the browser program 108 so as to engage in a typical online shopping session (block 406) in cooperation with the merchant 110 and the merchant's website. For example, the user may select merchandise displayed for sale on the website and then may control the browser program 108 to initiate the checkout phase of the transaction.

As is familiar to those who are skilled in the art, and to much of the public as well, the checkout phase of an online shopping transaction typically includes steps such as the user identifying himself/herself, selecting a shipping method, and entering an address to which the merchandise is to be shipped by the merchant. Moreover, and more pertinently, the checkout phase generally entails specification by the user of a manner of paying for the online shopping transaction. For this purpose, the merchant typically downloads a data entry screen to the user device to enable the user to enter the details of a payment account to which the user wishes to charge the transaction. (In some embodiments, this role of the merchant, and perhaps other roles as well, may be fulfilled by a Payment Service Provider retained by the merchant.) In accordance with some proposals, if the user is enrolled with a WSP, an option may be presented on the data screen, or a pop-up display may appear, to permit the user to indicate that he/she wishes to utilize his/her digital wallet in connection with the current online shopping transaction. At block 408 in FIG. 4, the user may operate the user device 106 to indicate via the browser program 108 that the user wishes to utilize the digital wallet maintained at the WSP computer 102 in connection with payment for the current transaction. This may have the effect of the browser program 108 sending, to the WSP computer 102, a request to employ the user's digital wallet (stored in the WSP computer 102) for the current online shopping transaction. The sending of the request to the WSP computer 102 may be direct or indirect. For example, the request from the browser program 108 may be relayed to the WSP computer 102 via the merchant 110, or by a more direct route via the internet (not separately shown) and/or via a mobile telecommunications network (not separately shown).

In response to the action taken at block 408, an interaction may occur via the browser program between the user and the WSP computer 102. In some embodiments, for example, a user authentication process (block 410) may take place. For example, the WSP computer 102 may require the user to provide a wallet PIN or password. Those who are skilled in the art will recognize that user submission of a PIN or password is only one of a number of different types of user authentication processes that may take place at this stage. For example, a biometric user authentication process may occur and/or the WSP computer 102 may engage in a challenge procedure to the user's mobile device.

In some embodiments, the WSP computer 102 may perform a device authentication process with respect to the user device 106 in addition to or instead of the user authentication process. In addition or alternatively, a program authentication process may occur with respect to the browser program 108.

Assuming that the user authentication process (and/or other authentication processes) is/are completed successfully, then the WSP computer 102 may provide to the user access to the user's digital wallet. If the user has more than one payment account that has been digitized into his or her wallet, then—as indicated at block 412—the WSP computer 102 may present to the user an opportunity to select a specific one of the payment accounts in the wallet for use in the current transaction.

Once account selection has occurred, or after user authentication, if there is only one account in the user's digital wallet, block 414 may follow. At block 414, and in accordance with aspects of this disclosure, the WSP computer 102 may generate a nonce value to be used in a transaction security process as will be described herein. In some embodiments, the nonce value may be generated randomly or pseudo-randomly by the WSP computer 102, but may be subject to one or more constraints such that the nonce value satisfy the format requirement for an account expiration date value. Thus, for example, the nonce value may consist of four digits, with the first digit constrained to be “0” or “1”; with the second digit constrained to be “0”, “1” or “2” if the first digit has the value “1”; and with the first digit not permitted to be “0” if the value of the second digit is “0”. Moreover, the constraints on the nonce value may be such that, if it were read as an expiration date value in the format “MMYY”, the indicated calendar month date would not be in the past relative to the current date on which the transaction is taking place.

Block 416 may follow block 414. At block 416, the WSP computer 102 may engage in a cryptographic process to generate a security code based on the nonce value generated at block 416 as well as based on the payment token. The payment token in question may have been stored in the user's digital wallet to represent the payment account selected by the user for the transaction (or may represent the only payment account in the user's wallet, as the case may be). The security code may be generated by the WSP computer 102 with a cryptographic key that the payment support services computer 104 had previously supplied to the WSP computer 102. The cryptographic key may be specific to the particular payment account or alternatively may be used by the WSP computer 102 in connection with many or all of the user payment accounts digitized into the WSP computer 102 by the payment support services computer 104. That is, the key may be the WSP key or an account-specific key.

In some embodiments, the security code may be in the form of a three digit number, so as to resemble a conventional security code such as those referred to as a “CVC” or “CVV”. In that form, the security code may fit an authorization message data field of the type used to carry such conventional three-digit security codes.

For example, in some embodiments, the security code generated at block 416 by the WSP computer 102 may be formed by truncating the result of digitally signing (with the above-mentioned cryptographic key) a concatenation of the payment token and the nonce value. For example, the operation of generating the security code may be represented by the following mathematical expression, where “SC” represents the security code, “WP_key” represents the above-mentioned cryptographic key, “Token” represents the above-mentioned payment token, “Nonce” represents the above-mentioned nonce value, “Sign” indicates a digital signing function, and “Truncate” indicates a truncation function:

SC=Truncate(Sign(Token∥Nonce,WP_key),3) (Equation 1)

Block 418 may follow block 416. At block 418, the WSP computer 102 may download/transmit the necessary payment credentials to the browser program 108 in the user device 106. The credentials may include the payment token, the nonce value (in the form of an account expiration date), and the security code. The downloading of these credentials may support the automatic filling in of the payment information for the e-commerce form by the browser program 108, and completion of the online shopping transaction (as between the user and the e-commerce website), as represented by block 420 in FIG. 4.

Block 422 may follow block 420. At block 422, the merchant 110 may transmit a payment account transaction authorization request message (“authorization request”) to the acquirer computer 112. The authorization request may be in a standard message format such as is customarily utilized for payment account system transaction processing. The nonce value may be carried in the data field of the message format that is commonly used for the account expiration date, and the security code generated at 416 may occupy the customary data field for a CVC or CVV or the like. The authorization request may contain other typical transaction data, such as transaction amount, merchant identification, etc.

At block 424, the acquirer computer may transmit the authorization request to the payment network (block 104 in FIG. 1, which also represents the payment support services computer).

In the process flow of FIG. 4, block 426 may follow block 424. At block 426, the payment support services computer 104 may receive the authorization request, or at least the payment credentials information contained in the authorization request. Using the same cryptographic key that the WSP computer 102 used to generate the security code, the payment support services computer 104 may verify the security code contained in the authorization request. For example, the payment support services computer 104 may duplicate the cryptographic process that was performed by the WSP computer 102 in generating the security code. That is, the payment support services computer 104 may cryptographically process the payment token with the nonce value by using the cryptographic key, to produce a presumed security code value. As before, the result of the cryptographic process may be truncated to three digits. The payment support services computer 104 may then compare the presumed security code value produced by its cryptographic process with the security code as received in the authorization request. Based on the result of the comparison, the payment support services computer 104 may generate a verification indication. For example, if the presumed security code value matches the received security code, the payment support services computer 104 may produce a verification indication to indicate that the security code has been verified. This indication may then be interpreted as evidence and/or proof that the WSP computer 102 was the source of the payment credentials and/or that the WSP computer 102 successfully conducted a user authentication process and/or a user device authentication process. Thus, the verification process performed by the payment support services computer 104 may tend to support a conclusion that the authorization request represents a valid transaction and/or that the risk associated with the authorization request is low. Accordingly, the verification indication may be utilized by the account issuer while performing risk scoring to determine whether to approve the authorization request.

In some embodiments, the verification indication may be used, possibly in conjunction with other information that is relevant to risk, to improve the likelihood that the account issuer will approve the authorization request. In some embodiments, the payment support services computer 104 may supply, for use by the account issuer, information that is indicative of prior experience with respect to the WSP's reliability in deterring or preventing fraudulent transactions. This may take the form of a score (which may be referred to as a “risk score”) for the WSP that is provided to the account issuer.

Block 428 in FIG. 4 may follow block 426. At block 428, the payment support services computer/payment network 104 may forward the authorization request and the security code verification indication to the payment account issuer 114. Part of this process step may involve a detokenization process so that the authorization request may be routed to the issuer using the PAN for the user's payment account.

In some embodiments, and in view of the limited number of nonce values available, it may be a practice not to use nonce values more than once for a given payment token, and to refresh/replace the payment token after a certain number of nonce values (say several hundred) have been used for a given token. It may also be a practice to disable a particular token or the underlying account after a small number of authorization requests for that token in which the security code verification was not successful.

In embodiments described above, the security code was generated based on the payment token and a nonce that is in a format for an account expiration date. However, in another embodiment, the security code generation may be based upon a transaction counter value in addition to the nonce and the payment token. In the latter embodiment, (a) the nonce may be free of the constraints described above in connection with block 414 in FIG. 4, (b) the nonce may be communicated directly from the WSP computer 102 to the payment support services computer 104, and (c) the transaction counter may be included in the payment credentials/authorization request in the account expiration date field. (That is, the transaction counter value may satisfy the format requirements for an account expiration date.) For this embodiment, the generation of the security code may be in accordance with the following mathematical expression, in which symbols have the same meaning as in Equation (1) above, and the symbol “TC” represents the transaction counter value.

SC=Truncate(Sign(Token∥Nonce∥TC,WP_key),3) (Equation 2)

In some embodiments, the key used in the cryptographic processing/digital signing may be a unique key established for the particular transaction. For example, to generate such a key, the account-specific key may be diversified with the transaction counter (TC). Such a key may in some cases be referred to as a “session key”.

With the embodiment summarized by Equation 2, an additional element of dynamism is provided in the generation of the security code, and the nonce value may be kept secret from potential eavesdroppers on the online shopping transaction. Moreover, it may be an acceptable practice with this embodiment to reuse the nonce value, and as noted above, the format of the nonce may be free of constraints.

In some embodiments, at least some of the functions described above as being performed by the WSP computer 102 may be performed by the above-mentioned CMS (credentials management service) computer 116 (FIG. 1). Among such functions may be, for example, the processes of blocks 414 and 416 of FIG. 4.

While the disclosure has been described in the context of an e-commerce transaction, the teachings of this disclosure may also be applicable to, for example, in-store payment account transactions with payment-enabled mobile devices that are supported for payment purposes “in the cloud”.

As used herein and in the appended claims, the term “e-commerce” refers to purchases via a merchant's online store, and/or “in-aisle” shopping/payment or any other transaction in which payment is made over the internet or via interaction by a mobile application with a remote server or other computer.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices which represent clients submitting service requests.

The flow charts and descriptions thereof herein should not be understood to prescribe a fixed order of performing the method steps described therein. Rather, the method steps may be performed in any order that is practicable.

As used herein and in the appended claims, the term “payment account” includes a credit card account, a deposit account that the account holder may access using a debit card, a prepaid card account, or any other type of account from which payment transactions may be consummated. The terms “payment account”, “payment card system account”, “payment card account” and “primary account number” (PAN) are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a request for a transaction;
in response to the request, generating a nonce value;
using a cryptographic key to cryptographically process a payment token with the nonce value to produce a security code; and
transmitting the payment token, the nonce value and the security code.

2. The method of claim 1, wherein the nonce value is in a format that matches a standard format of a payment account expiration date.

3. The method of claim 2, wherein the request for the transaction is received from a browser program.

4. The method of claim 3, wherein the token, the nonce value and the security code are transmitted to the browser program.

5. The method of claim 4, further comprising:
performing at least one of:
(a) a user authentication process with respect to a user of the browser program;
(b) a device authentication process with respect to a user device on which the browser program runs; and
(c) a program authentication process with respect to the browser program.

6. The method of claim 2, wherein the security code is a three-digit number.

7. The method of claim 1, wherein the receiving and transmitting steps are performed by a first computer, said first computer operated by a wallet service provider.

8. The method of claim 7, wherein the generating step is performed by a second computer that is different from the first computer, the second computer operated by a credentials management service.

9. The method of claim 7, wherein the generating step is performed by the first computer.

10. A method comprising:
receiving an authorization request for a payment account transaction, the authorization request including a payment token, a nonce value and a security code, the nonce value in a format that matches a format of a payment account expiration date;
using a cryptographic key to cryptographically process the payment token with the nonce value to produce a presumed security code value;
comparing the presumed security code value with the security code included in the authorization request; and
generating a verification indication based at least in part on a result of the comparing step.

11. The method of claim 10, further comprising:
inserting the verification indication into the authorization request; and
transmitting, to an account issuer, the authorization request including the inserted verification indication.

12. The method of claim 11, further comprising:
transmitting, to the account issuer, a risk score relative to an entity that generated the security code.

13. The method of claim 12, wherein the risk score is transmitted to the account issuer as part of the authorization request that includes the inserted verification indication.

14. A method comprising:
receiving a request for a transaction;
in response to the request, generating a nonce value and a transaction counter value;
using a cryptographic key to cryptographically process a payment token with the nonce value and the transaction counter value to produce a security code;
transmitting the payment token, the transaction counter value and the security code to a first device; and
transmitting the nonce value to a second device that is different from the first device.

15. The method of claim 14, wherein the transaction counter value is in a format that matches a standard format of a payment account expiration date.

16. The method of claim 15, wherein the request for the transaction is received from a browser program that runs on the first device.

17. The method of claim 16, wherein the second device is a payment support services computer.

18. The method of claim 17, further comprising:
performing at least one of:
(a) a user authentication process with respect to a user of the browser program;
(b) a device authentication process with respect to a user device on which the browser program runs; and
(c) a program authentication process with respect to the browser program.

19. The method of claim 18, wherein the security code is a three-digit number.

20. The method of claim 14, wherein the receiving and transmitting steps are performed by a computer operated by a wallet service provider.
